(19) United States
(12) Patent Application Publication
(10) Pub. No.: US 2020/0382656 A1
(43) Pub. Date: Dec. 3, 2020

(54) INFORMATION PROCESSING DEVICE AND DISPLAY CONTROL METHOD

(71) Applicant: CANON KABUSHIKI KAISHA, Tokyo (JP)

(72) Inventor: Nobuhiro Ogawa, Matsudo-shi (JP)

(21) Appl. No.: 16/883,037

(22) Filed: May 26, 2020

(30) Foreign Application Priority Data
May 31, 2019 (JP) 2019-103171

(51) Int. Cl. H04N 1/00; H04W 4/80; G06F 3/12

(52) U.S. Cl. CPC H04N 1/00214; H04W 4/80; G06F 3/1236; G06F 3/1212; G06F 3/1292

(57) ABSTRACT

Using a signal of a short-range wireless communication emitted from a communication device, information of a relative position between an information processing device and a communication device is acquired. In a case where a display unit is caused to display information related to the communication device, the display unit is caused to display information indicating the relative positional relationship, together with the information related to the communication device.

### BACKGROUND OF THE INVENTION

### Field of the Invention

The present invention relates to an information processing device capable of wireless communication and a display control method.

### Description of the Related Art

Notification information for displaying information related to a communication device such as a printer being received, in an information processing device, from an external unit such as a smart phone, and a notification screen being displayed based on this notification information is known. Japanese Patent Laid-Open No. 2017-134628 describes that a portable terminal device receives a push notification from a push notification distribution server and executes processing to notify of the push notification.

A user, after confirming the displayed notification screen, may move to a device related to what was notified on the notification screen. However, a user cannot know where the device related to what was notified is located by the simple display of a notification screen.

### SUMMARY OF THE INVENTION

The present invention provides an information processing device and a display control method by which user convenience is improved in the case of displaying notification information related to a communication device.

The present invention in one aspect provides a display control method performed on an information processing device operable to communicate with a communication device, the method comprising: acquiring information of a relative position between the information processing device and the communication device specified based on a signal emitted from the communication device; causing a display unit to display predetermined notification information that is different to the relative position information and that is related to the communication device and the relative position information, together with information related to the communication device.

By virtue of the present invention, it is possible to improve user convenience in a case of displaying notification information related to a communication device.

Further features of the present invention will become apparent from the following description of exemplary embodiments with reference to the attached drawings.

### BRIEF DESCRIPTION OF THE DRAWINGS

FIG. 1 is a view illustrating a configuration of a system including an information processing device and a communication device.

FIG. 2 is a view illustrating consumed power according to advertising information transmission/reception processing.

FIG. 3 is a view illustrating consumed power according to advertising information transmission/reception processing.

FIG. 4A and FIG. 4B are views illustrating a PIN code display screen.

FIG. 5 is a view illustrating a structure of advertising information.

FIG. 6 is a view for describing a function in which the information processing device detects a position of the communication device.

FIG. 7 is a view for describing a method by which the information processing device detects a direction of the communication device.

FIG. 8 is a view for describing a method by which the information processing device detects a direction of the communication device.

FIG. 9 is a view illustrating a structure of advertising information.

FIG. 10 is a view illustrating a screen displayed in a push notification function.

FIG. 11 is a view illustrating a layered structure of GATT data.

FIG. 12 is a view illustrating GATT data.

FIG. 13 is a view for describing BLE communication between the information processing device and the communication device.

FIG. 14 is a flow chart illustrating display control processing in the information processing device.

FIG. 15 is a view illustrating a configuration of a communication system that performs a push notification.

FIG. 16 is a view illustrating a notification screen displayed on the information processing device.

FIG. 17 is a flow chart illustrating display control processing in the information processing device.

FIG. 18 is a view illustrating notification information in which device installation location information is embedded.

FIG. 19 is a view illustrating a notification screen displayed on the information processing device.

FIG. 20 is a flow chart illustrating display control processing in the information processing device.

FIG. 21 is a view illustrating a notification screen displayed on the information processing device.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

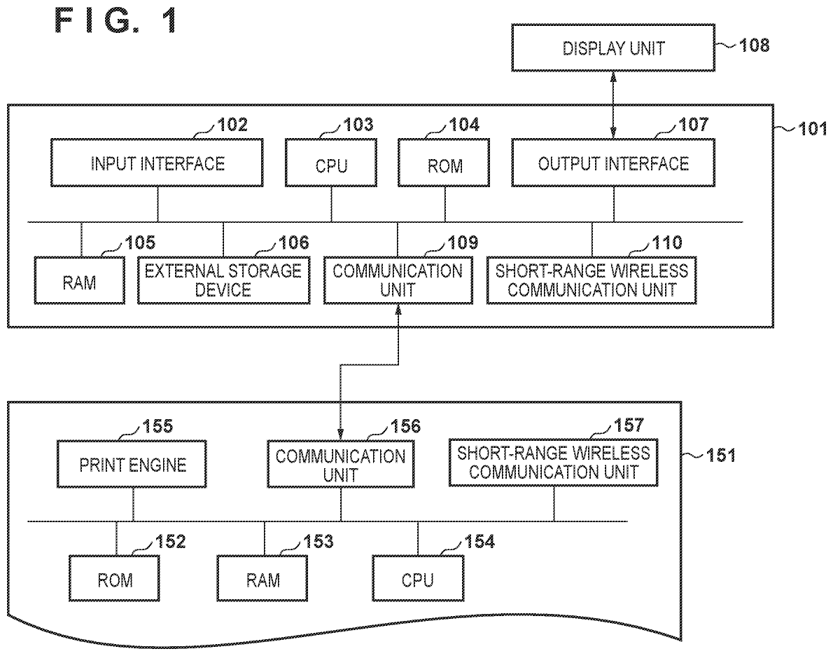

An information processing device and a communication device that are included in a communication system of the present embodiment will be described. FIG. 1 is a view illustrating a configuration of the respective devices in a system including an information processing device and a communication device. In the present embodiment, a smart phone will be described as an example of the information processing device. However, limitation is not made to the smart phone, and various devices such as a mobile terminal, a personal computer (PC), a tablet terminal, a PDA (Personal Digital Assistant), a digital camera, or the like that comprise the block configuration of FIG. 1 may be used. Also, a printer will be described as an example of the communication device. However, limitation is not made to the printer, and other devices that comprise the block configuration in FIG. 1 and can communicate with the information processing device may be used. For example, an ink-jet printer, a full-color laser beam printer, a monochrome printer, a copying machine or facsimile device, a mobile terminal, a smart phone, a notebook PC, a tablet terminal, a PDA, a digital camera, a music playback device, a television, or the like may be used. Also, a multi-function device having a plurality of functions such as a copy function, a FAX function, and a print function may be used as the communication device.

Hereinafter, the configurations of the information processing device and the communication device will be described with reference to FIG. 1. An information processing device 101 comprises an input interface 102, a CPU 103, a ROM 104, a RAM 105, an external storage device 106, an output interface 107, a display unit 108, a communication unit 109, and a short-range wireless communication unit 110.

The input interface 102 is an interface for receiving data input and operation instructions from a user, and is configured to include a keyboard, buttons, a touch panel, or the like. Note that the later-described output interface 107 and input interface 102 may be in the same configuration, and configuration may be taken so as to perform screen output and receive operations from a user by the same configuration.

The CPU 103 is a system control unit and comprehensively controls the information processing device 101 as a whole. The ROM 104 stores fixed data such as control programs that the CPU 103 executes, data tables, and an embedded operating system (OS) program. For each control program stored in the ROM 104, software execution control such as scheduling, task switching, and interrupt processing is performed under control of the embedded OS.

The RAM 105 is configured by an SRAM (Static Random Access Memory) or the like that requires a backup power supply. Note that in the RAM 105, data is held by a primary battery for data backup (not shown), and it is possible to store data such as program control variables in a non-volatile manner. Also, there are cases where a memory area for storing setting information and management data of the information processing device 101 and the like is arranged in the RAM 105. The RAM 105 is also used as a main memory and a work memory of the CPU 103. The external storage device 106 stores predetermined applications having a print execution function and a notification function. Also, the external storage device 106 stores various programs such as an information transmission/reception control program for transmission/reception with a communication device 151 connected via the communication unit 109 and various information that such programs use.

The output interface 107 is an interface with the display unit 108 which performs state notification and screen display for the information processing device 101. The display unit 108 is configured to include an LED (light emitting diode), an LCD (liquid crystal display), and the like, and displays notifications of the state of the information processing device 101 and user interface screens and the like. Note that configuration may also be taken such that on the display unit 108, a software keyboard comprising numeral input keys, a mode setting key, a deciding key, a cancel key, a power supply key, and the like is disposed, and thereby input from the user is received via the display unit 108.

The communication unit 109 is connected to the communication device 151 and executes data communication. For example, the communication unit 109 can connect to an access point (not shown) within the communication device 151. By the communication unit 109 and an access point within the communication device 151 being connected, the information processing device 101 and the communication device 151 are enabled to communicate with each other. Note that the communication unit 109 may communicate directly with the communication device 151 by wireless communication, and may communicate with the communication device 151 via an external access point present in an external unit. For example, Wi-Fi (WirelessFidelity) (registered trademark) and Bluetooth (registered trademark) may be used as the wireless communication method. Also, the access point is a device such as a wireless LAN router. Note that, in the present embodiment, the method of the information processing device 101 and the communication device 151 connecting directly rather than through an external access point is called “direct connection method”. Also, a method in which the information processing device 101 and the communication device 151 are connected with each other via an external access point is referred to as an “infrastructure connection method”.

The short-range wireless communication unit 110 executes data communication by short-range wireless communication with the communication device 151. The short-range wireless communication unit 110 performs communication by a different communication method to the communication unit 109. The short-range wireless communication unit 110 can connect to a short-range wireless communication unit 157 within the communication device 151. Note that in the present embodiment, Bluetooth 5.1 is assumed to be used as the communication method of the short-range wireless communication unit 110. Note that in Bluetooth 5.1, both the Classic Bluetooth and the Bluetooth Low Energy (BLE) standards are included, but in the present embodiment, BLE is assumed to be used as the communication method of the short-range wireless communication unit 110.

The communication device 151 comprises a ROM 152, a RAM 153, a CPU 154, a print engine 155, a communication unit 156, and the short-range wireless communication unit 157. The communication unit 156 comprises an access point for connecting with the information processing device 101 as an access point within the communication device 151. This access point can connect to the communication unit 109 of the information processing device 101. Note that the communication unit 156 may communicate directly with the information processing device 101 by wireless communication and may communicate via an access point. For example, Wi-Fi (registered trademark) or Bluetooth (registered trademark) may be used as the communication method. Also, the communication unit 156 may comprise hardware that functions as an access point, and may operate as an access point by software for functioning as the access point.

The short-range wireless communication unit 157 executes data communication by short-range wireless communication with the information processing device 101. The short-range wireless communication unit 157 performs communication by a different communication method to the communication unit 156. The short-range wireless communication unit 157 can connect with the short-range wireless communication unit 110 within the information processing device 101. Note that, in the present embodiment, it is assumed that Bluetooth 5.1, and in particular BLE is used as the communication method of the short-range wireless communication unit 157.

The RAM 153 is configured by an SRAM that requires a backup power supply. Note that the RAM 153 holds data by using a primary battery for data backup (not shown), and therefore can store data such as program control variables and the like in a non-volatile manner. Also, the memory area for storing setting information and management data of the communication device 151 may be arranged in the RAM 153. Also, the RAM 153 may be used as a main memory and a work memory of the CPU 154, and, for example, functions as a reception buffer for temporarily saving print information received from the information processing device 101.

The ROM 152 stores fixed data such as control programs that the CPU 154 executes, data tables, and an OS program. In the present embodiment, for each control program stored in the ROM 152, under the control of the embedded OS stored in the ROM 152, software execution control such as scheduling, task switching, and interrupt processing is performed.

The CPU 154 is a system control unit, and comprehensively controls the communication device 151 as a whole. For example, the CPU 154 controls each unit to, based on information stored in the print engine 155 or the RAM 153 or a print job received from the information processing device 101, form an image on a recording medium such as a paper sheet using a print agent such as ink, and output the print result. At that time, high-speed communication for a large transmission data amount is required for the print job transmitted from the information processing device 101, and therefore reception is conducted by the communication unit 156 which is capable of communicating at higher speed than the short-range wireless communication unit 157. Note that in the communication device 151, a memory such as an external HDD or an SD card may be equipped as an option unit, and configuration may also be taken such that a print job received from the information processing device 101 or the like is stored in such a memory.

The respective configurations in the information processing device 101 and the communication device 151 are illustrated in FIG. 1, but limitation is not made to the configurations illustrated in FIG. 1, and configuration may be taken to include other blocks in each device as appropriate.

In the present embodiment, the information processing device 101 stores a predetermined application in the ROM 104 or the external storage device 106. The predetermined application is, for example, an application program for transmitting to a printing device a print job for causing image data or document data in the information processing device 101 to be printed. An application having such a function is hereinafter called a “print app”. Note that the print app may have functions other than the print function. For example, if the printing device has a scan function, the print app may have a function for causing the printing device to scan a set original, a function for making other settings on the printing device, a function for confirming the state of the printing device, and the like. In other words, in addition to print jobs, the print app may have a function for transmitting to the printing device scan jobs or setting jobs. Also, the predetermined application is not limited to the print app, and may be an application program that has a function other than for printing.

In the present embodiment, the short-range wireless communication unit 110 and the short-range wireless communication unit 157 are described as performing communication according to BLE. Note that in the present embodiment, the short-range wireless communication unit 157 functions as an advertiser (or a slave) that broadcasts later-described advertising information, and the short-range wireless communication unit 110 functions as a scanner (or a master) that receives advertising information. Also, the communication unit 109 and the communication unit 156 are described as performing communication by a wireless LAN (Wi-Fi).

Here, processing for transmission of advertising information and reception of a BLE connection request in the BLE standard is described. In the present embodiment, as described above, the short-range wireless communication unit 157 operates as a slave device, and therefore the short-range wireless communication unit 157 performs the foregoing processing. The short-range wireless communication unit 157 performs communication by dividing a 2.4 GHz frequency band into 40 channels (0 to 39ch). The short-range wireless communication unit 157 uses the 37th to 39th channels therein for transmission of advertising information or reception of a BLE connection request, and uses 0th to 36th channels for data communication after making the BLE connection.

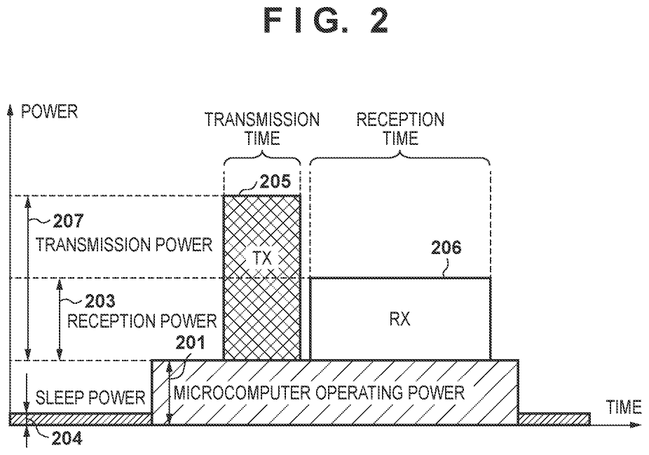

In FIG. 2, the ordinate indicates power consumed by wireless communication signals of the short-range wireless communication unit 157 and the abscissa indicates time, and power consumed when advertising information is transmitted using one channel is indicated for each process. Tx 205 indicates total power consumption in transmission processing in which advertising information is broadcasted, and Rx 206 indicates total power consumption in reception processing in which the reception device for receiving a BLE connection request is enabled. Transmission power 207 indicates an instantaneous power consumption in accordance with transmission processing, and reception power 203 indicates an instantaneous power consumption in accordance with reception processing. Also, microcomputer operating power 201 indicates an instantaneous power consumption for a case where a microcomputer is operating in the short-range wireless communication unit 157. Note that the microcomputer operates before/after or between Tx 205 and Rx 206 because the microcomputer must be activated in advance in order to execute or stop transmission/reception processing. Also, in a case where transmission of advertising information is performed on a plurality of channels, the consumed power increases in proportion to the number of channels on which the advertising information is transmitted. Also, while the microcomputer is not operating and the short-range wireless communication unit 157 is in a power saving state, the sleep power 204 is the instantaneous power consumption of the short-range wireless communication unit 157. As described above, after the short-range wireless communication unit 157 uses a predetermined channel to perform transmission processing, it waits for the BLE connection request to be transmitted from the information processing device 101 by performing reception processing for a fixed time using the same channel.

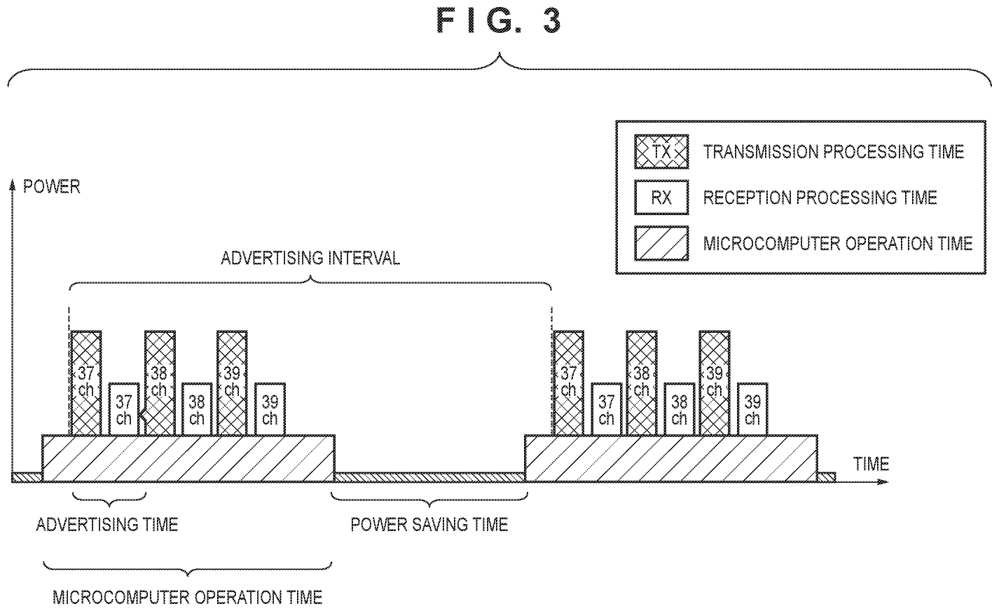

As illustrated in FIG. 3, the short-range wireless communication unit 157, after repeating the advertising information transmission processing and reception processing three times for each channel, stops operation of the microcomputer and enters a power saving state for a fixed time. Hereinafter, the combination of advertising information transmission processing and reception processing according to a predetermined channel will be called “advertising”. Also, the time interval at which advertising information is transmitted by a combination of predetermined channels will be called the “advertising interval”. Note that the number of times that advertising is repeated until the power saving state is entered after performing advertising a first time can be modified as appropriate if less than or equal to three times. Also, for the advertising channels in FIG. 3, the 37th channel, the 38th channel, the 39th channel are used sequentially in that order, but this order may be random, and the order may be different between the advertising of the first time and of the second time and the advertising of the third or more time.

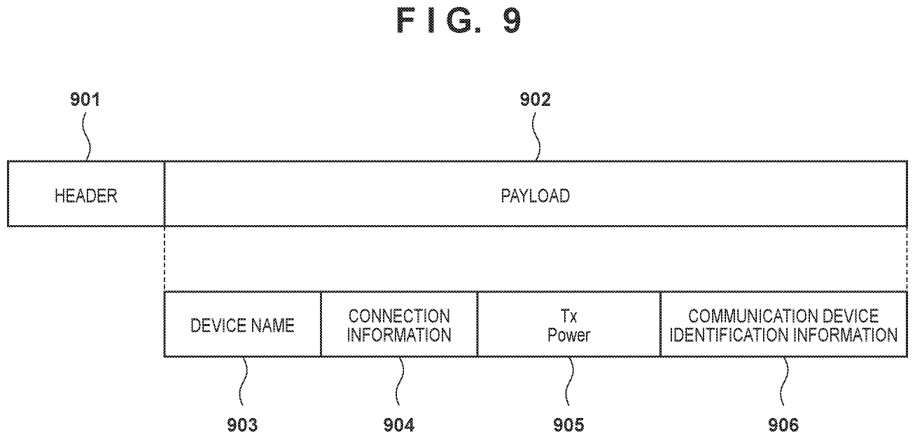

FIG. 9 is a view illustrating an example of a structure of advertising information that the short-range wireless communication unit 157 broadcasts to the periphery of the communication device 151. The short-range wireless communication unit 157 performs initialization processing when the supply of power is initiated and the advertising state is entered. When the short-range wireless communication unit 157 enters the advertising state, it periodically broadcasts advertising information to the periphery based on an advertising interval. The advertising information is a signal including basic header information (identification information for identifying the device that transmits the advertising information), and is configured to include a header 901 and a payload 902. The information processing device 101 can find out about the presence of the communication device 151 by receiving the advertising information. Furthermore, the information processing device 101, by transmitting a BLE connection request to the communication device 151, can make a BLE connection with the communication device 151. The header 901 is a region in which a type of advertising information and a size of the payload 902 and the like is stored. In the payload 902, information such as a device name 903 (identification information), installation profile information, connection information 904 for the BLE connection with the communication device 151, the transmission power of the advertising information (Tx Power) 905 used to detect the distance, and the like is stored. Also, the identification information 906 for the communication device 151 is included in the advertising information. The MAC address of the communication device 151, the service information of the communication device 151, an SSID and password of the access point in the communication device 151 or the like correspond to the identification information 906 for the communication device 151.

In the present embodiment, in the case where the power supply of the communication device 151 is turned on, the short-range wireless communication unit 157 enters the advertising state, and transmission of advertising information is initiated. However, the timing at which the short-range wireless communication unit 157 starts transmitting the advertising information is not limited to the above, and, for example, may be a timing at which a predetermined operation is performed in order to enable the BLE function. For example, configuration may be taken so that the short-range wireless communication unit 157 first transmits the first advertising information, and in the case where it receives from the information processing device 101 a scan response in response to the first advertising information, the short-range wireless communication unit 157 transmits second advertising information whose content is different to that of the first advertising information. For example, the first advertising information includes information related to a transmission power for the advertising information and identification information of the short-range wireless communication unit 157, and the second advertising information includes identification information of the communication device 151 and information related to functions and hardware of the communication device 151. In the case of such a configuration, for example, the print app is configured to handle the second advertising information. In the present embodiment, the advertising information that the print app handles is the second advertising information.

FIG. 6 is a view for describing a function in which, using advertising information that the short-range wireless communication unit 157 within the communication device 151 transmits, the information processing device 101 detects the position of the communication device 151. The short-range wireless communication unit 110 within the information processing device 101 comprises an antenna 601, an antenna 602, and an antenna 603, and the short-range wireless communication unit 157 within the communication device 151 comprises an antenna 604, an antenna 605, and an antenna 606. Note that the number of antennas provided in the short-range wireless communication unit 110 and the short-range wireless communication unit 157 is not limited, and the number of antennas may be one or two or four or more. Also, the numbers of antennas that the short-range wireless communication unit 110 and the short-range wireless communication unit 157 are provided with may be different to each other. Also, in FIG. 6, the antennas that the short-range wireless communication unit 110 and the short-range wireless communication unit 157 are provided with are described as being arranged in a straight line in the description, but limitation is not made to this, and the arrangement of antennas is not limited to the arrangement in the figure.

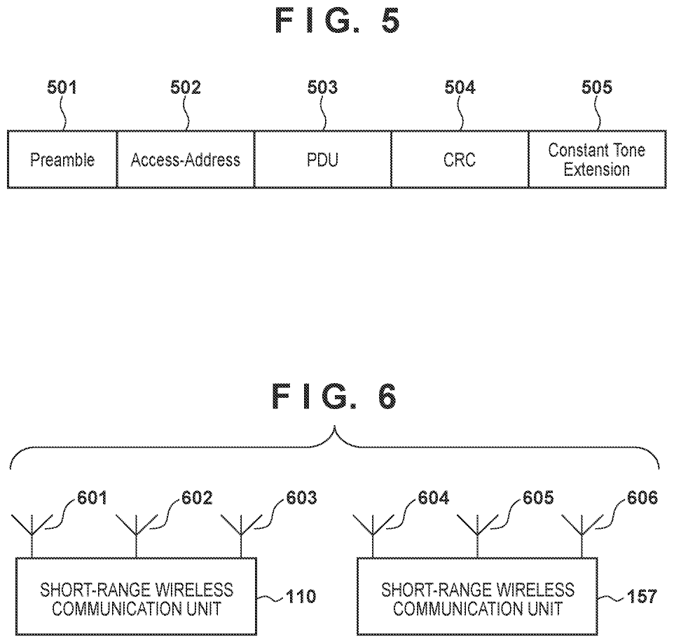

FIG. 5 is a view illustrating an example of a structure of advertising information that the short-range wireless communication unit 157 within the communication device 151 transmits to the information processing device 101 in order to detect the distance to the communication device 151 and the direction in which the communication device 151 is positioned. A Constant Tone Extension (CTE) 505 is data used to detect the direction of the communication device 151 in relation to the information processing device 101. A Preamble 501 is data for clock synchronization for when the information processing device 101 receives advertising information of the communication device 151. An Access-Address 502 is data for frame synchronization for when the information processing device 101 receives advertising information of the communication device 151. A PDU 503 is an actual data portion in the advertising information that the communication device 151 transmits. Note that the header 901 and the payload 902 which are advertising information illustrated in FIG. 9 are information included within the PDU 503. A CRC 504 is an error detection code value for when communicating the PDU 503.

The distance between the information processing device 101 and the communication device 151 is detected based on the transmission power (Tx Power) 905 of the advertising information included in the advertising information broadcasted from the communication device 151 and its reception strength.

Methods by which the information processing device 101 estimates the direction of the communication device 151 are classified into (1) a method realized in a case where the short-range wireless communication unit 110 (the receiving side) has multiple antennas and (2) a method realized in a case where the short-range wireless communication unit 157 has multiple antennas.

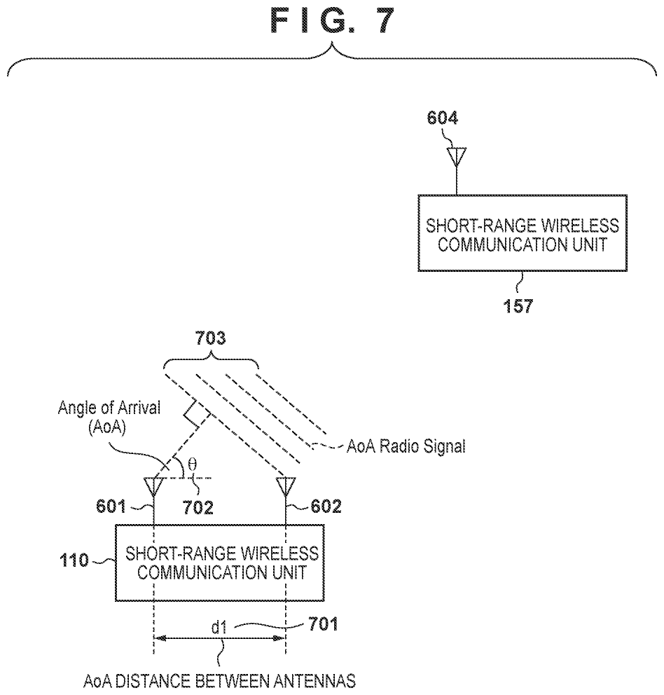

Method (1) will be described using FIG. 7. In the configuration of FIG. 7, the short-range wireless communication unit 110 estimates the angle of arrival of received radio waves based on a phase difference between radio waves when they arrive at the respective antennas, using the plurality of antennas of the short-range wireless communication unit 110 which is the device on the receiving side. Hereinafter, the angle of arrival may be referred to as “AoA”.

In FIG. 7, the short-range wireless communication unit 157 uses the antenna 604 to transmit advertising information by a radio frame (AoA Radio Signal 703) in which the CTE 505 is included. The short-range wireless communication unit 110 receives this radio frame at the plurality of antennas (at both the antenna 601 and the antenna 602). At that time, the distance between antennas 701 between the antenna 601 and the antenna 602 is made to be d1, and the AoA 702 is made to be 0. In such a case, radio waves received by the antenna 601 are received after passing over a distance that is d1×cos(θ) longer than the radio waves received in the antenna 602. Accordingly, when the wavelength of radio waves is made to be λ, the phase of the radio waves received in the antenna 601 is delayed with respect to the phase of the radio waves received in the antenna 602 by

ψ1=2π×(d1×cos(θ)/λ) Equation (1).

Here, ψ1 is the difference between the phase of radio waves received in the antenna 602 and the phase of radio waves received in the antenna 601. From Equation (1), the AoA 702 can be calculated as follows:

θ=arccos((ψ1×λ)/(2π×d1)) Equation (2).

Accordingly, the information processing device 101, by performing the calculation as in Equation (2), can estimate the direction of the communication device 151.

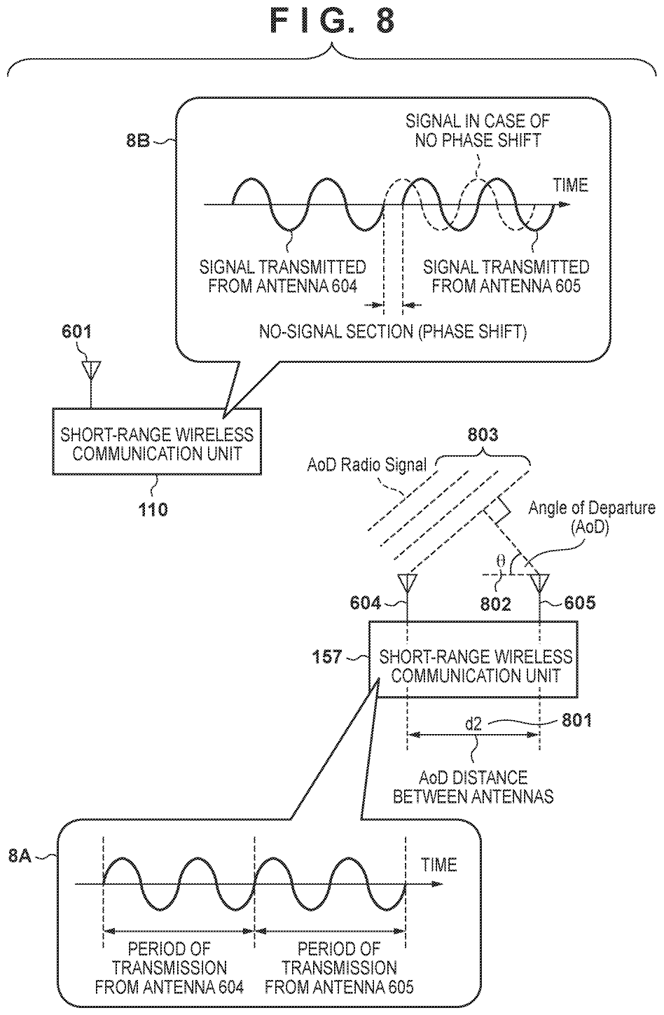

Next, the aforementioned method (2) will be described using FIG. 8. In the configuration of FIG. 8, advertising information is transmitted by a radio frame (an AoD Radio Signal 803) in which the CTE 505 is included in respectively different periods from the multiple antennas of the short-range wireless communication unit 157 which is the device on the transmitting side. For example, as illustrated in configuration 8A of FIG. 8, the transmission period of the AoD Radio Signal 803 from the antenna 604 is set and the transmission period of the AoD Radio Signal 803 from the antenna 605 is assumed to be set immediately after that. In such a case, in the short-range wireless communication unit 157, between the transmission of the AoD Radio Signal 803 from the antenna 604 and the transmission of the AoD Radio Signal 803 from the antenna 605, there is no occurrence of a no-signal section. Meanwhile, the short-range wireless communication unit 110 can receive these wireless signals in a form shown as configuration 8B in FIG. 8. In other words, since the signal transmitted by the antenna 605 travels along a longer path than the signal transmitted by the antenna 604, and it arrives at the short-range wireless communication unit 110 later, a no-signal section arises between these signals. Also, when the antenna 605 has transmitted a signal first, the signal transmitted from the antenna 604 arrives at the short-range wireless communication unit 110 prior to all of the signal transmitted from the antenna 605 arriving at the short-range wireless communication unit 110. Also, in a case where a no-signal section of a predetermined length is set after the completion of a signal transmission period of the antenna 604 and a period of signal transmission from the antenna 605 is set, in the wireless signal received in the short-range wireless communication unit 110, a no-signal section longer than the predetermined length is observed. Similarly, when a no-signal section of a predetermined length is set after the completion of a signal transmission period of the antenna 605, and a period of signal transmission from the antenna 604 is set, in the wireless signal received in the short-range wireless communication unit 110, a no-signal section shorter than the predetermined length is observed. In this way, signals transmitted from a plurality of antennas are observed as a deviation of timings in accordance with each path length in the short-range wireless communication unit 110. Note that due to the observation of a deviation in timings, information on scheduling as to which signal is transmitted from which antenna and at which timing (for example, from the short-range wireless communication unit 157 or the other device) is notified to the short-range wireless communication unit 110 in advance.

Incidentally, a deviation in reception timings corresponds to a deviation in phases of the reception signal. For example, in the example of FIG. 8, the signal transmitted from the antenna 605 travels along a path d2×cos(φ) longer than that of the signal from transmitted from the antenna 604, and arrives at the short-range wireless communication unit 110. Here, d2 is the distance between antennas 801 between the antenna 604 and the antenna 605. When a light transmission speed is made to be c, a deviation of reception timing of d2×cos(φ)/c seconds is generated due to this difference in path length, and at the same time, a phase difference of

ψ2=2π×d2×cos(φ)/λ Equation (3)

is also generated. Note that, λ is the radio wave wavelength as described above. Also, φ is an angle that the straight line connecting the short-range wireless communication unit 157 and the short-range wireless communication unit 110 and the straight line connecting the antenna 604 and the antenna 605 form. Note that the angle thus formed is referred to as the Angle of Departure, and hereinafter it is denoted AoD 802. The short-range wireless communication unit 110 can specify the phase difference ψ2 by, for example, performing correlation detection on the basis of the first received signal among the plurality signals transmitted from the short-range wireless communication unit 157 or the like. Then, the short-range wireless communication unit 110, using Equation (3), can calculate the AoD 802 as following using the phase difference ψ2

φ=arccos((ψ2×λ)/(2π×d2)) Equation (4).

Incidentally, the short-range wireless communication unit 110 acquires the information of the distance between antennas d2 from the short-range wireless communication unit 157 or the other device in advance. The short-range wireless communication unit 110, by calculating the AoD 802 as with Equation (4), can specify a direction of the short-range wireless communication unit 110 as seen from the short-range wireless communication unit 157. Also, by the short-range wireless communication unit 110 knowing the arrangement of the antenna 604 and the antenna 605, the short-range wireless communication unit 110 can estimate the direction from which the radio waves came based on the AoD 802. In other words, when the antenna 604 is arranged on the west side of the antenna 605, and the AoD 802 is estimated to be 45°, the short-range wireless communication unit 110 can estimate that the radio waves came from the southeast direction. Furthermore, the short-range wireless communication unit 110 can estimate the distance from the short-range wireless communication unit 157 by the reception intensity of radio waves and a transmission power of the radio waves, and thereby can recognize a positional relationship with respect to the short-range wireless communication unit 157. Also, the short-range wireless communication unit 110 can estimate its position with a high level of accuracy by acquiring information on where the short-range wireless communication unit 157 is positioned.

In the above, the information processing device 101 is described as detecting one direction of the communication device 151, but there is no limitation to this configuration. For example, the information processing device 101 may detect two or more directions of the communication device 151. Also, the information processing device 101, by detecting two or more directions of the communication device 151 and referring to each piece of detection data, compared to a configuration in which one direction of the communication device 151 is detected, can detect a distance and a direction as a relative positional relationship between the devices with a higher level of accuracy.

Here, an overview of GATT (Generic Attribute Profile) communication in the BLE standard will be explained. The GATT is a profile for controlling reading/writing (transmitting/receiving) of information in the BLE standard. In the GATT communication, two roles—GATT client and GATT server—are defined on the basis of a data transfer source and a data transfer destination. The GATT client transmits a request to the GATT server, and receives a response from the GATT server. In the present embodiment, the information processing device 101 is the GATT client. The GATT client can execute the reading of information stored in a storage region in the short-range wireless communication unit of the GATT server, and can execute the writing of information to the storage region. When the GATT server receives the request from the GATT client, the GATT server responds to the GATT client. In the present embodiment, the communication device 151 is the GATT server, and the information processing device 101 is the GATT client. Note that, the GATT server operates as a device that stores information such as status information of the GATT server.

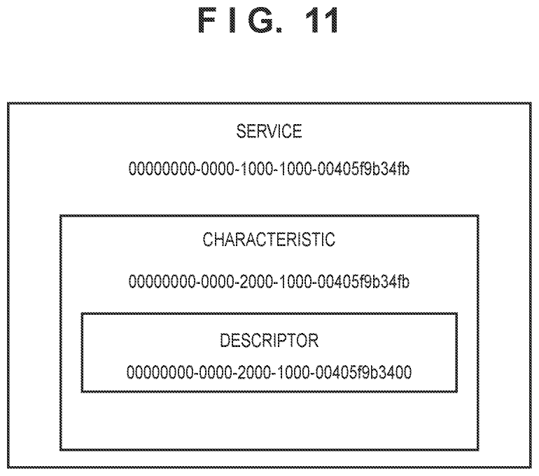

Next, the GATT data format will be explained. The GATT data, as illustrated in FIG. 11, has a layered structure including three elements referred to as a service, a characteristic, and a descriptor. Note that the descriptor need not be present, and in the present embodiment, the descriptor is assumed to not be present in the GATT data that the short-range wireless communication unit 157 configures. The service, the characteristic, and the descriptor can be identified by a UUID (Universally Unique Identifier) represented by 32 digits. The UUID is used as an identifier for identifying an object uniquely in software. The UUID is a 128-bit number, and is ordinarily represented in hexadecimal, such as 550e8400-e29b-41d4-a716-446655440000. Note that, the service, the characteristic, and the descriptor may be defined by the Bluetooth SIG standard and may be vendor specific. The UUID which is vendor specific is represented in 32 digits as described above, and the UUID which is defined by the Bluetooth SIG standard is represented in 4 digits. For example, a UUID which is defined by the Bluetooth SIG standard is represented as “2A49”.

A service is formed by grouping attributes in GATT data in common divisions, and each service includes one or more characteristics. A single value is set for each characteristic. The descriptor is set to an attribute value which is used when the characteristic requires additional information. Read and write attributes, which are setting values indicating whether or not reading and writing of a GATT client is permitted, can be set for each of the service, the characteristic, and the descriptor.

The GATT client, by designating the UUID of a service and a characteristic respectively, can execute read and write in relation to a value set for a designated characteristic. However, whether read and write can be executed is based on read and write attributes set for each service and characteristic.

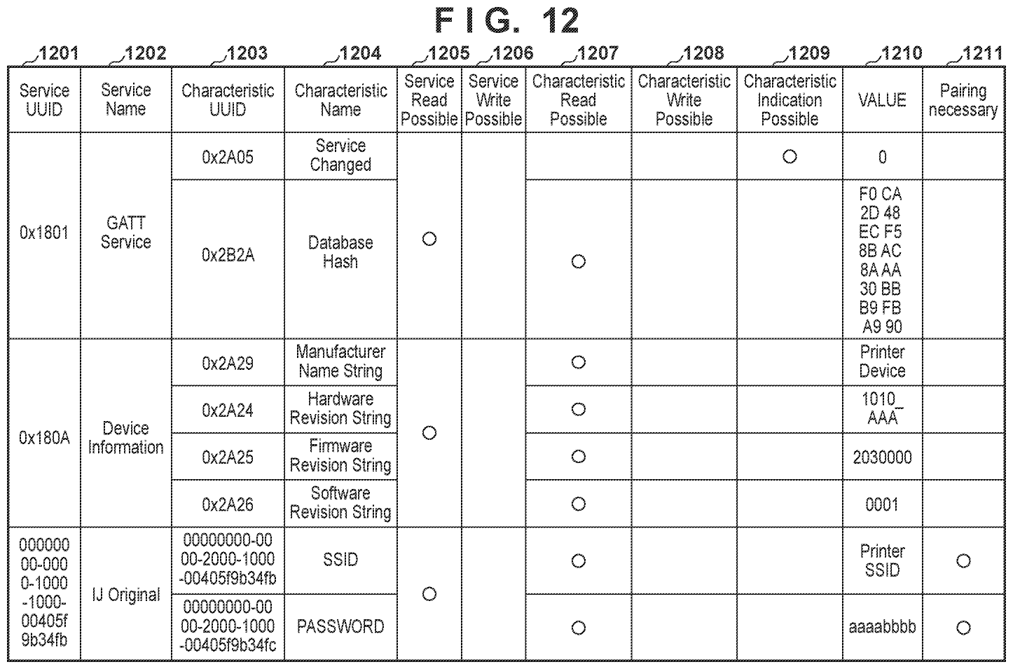

FIG. 12 is a view showing an example of GATT data constructed by the short-range wireless communication unit 157. In GATT data of FIG. 12, “Service UUID” 1201 indicates the UUID assigned to each service. “Service name” 1202 indicates a name of each service. “Characteristic UUID” 1203 indicates a UUID assigned to each characteristic. “Characteristic name” 1204 indicates a name of each characteristic. “Service read possible” 1205 indicates whether the information processing device 101 can read a value related to each service. “Service write possible” 1206 indicates whether the information processing device 101 can write a value related to each service. “Characteristic read possible” 1207 indicates whether the information processing device 101 can read a value related to each characteristic. “Characteristic write possible” 1208 indicates whether the information processing device 101 can write a value related to each characteristic. “Characteristic indication possible” 1209 indicates whether it is possible to indicate (notify) to the information processing device 101 in a case where the communication device 151 updates a value related to a respective characteristic. The “O” in the figure indicates that indication is possible, and if it is a blank, it indicates that indication is not possible.

“Pairing necessary” 1211 indicates whether, if unpaired, a value related to a respective characteristic is not permitted to be written or read in the information processing device 101. The “O” in the figure indicates that reading or writing is possible, and if it is a blank, it indicates that reading or writing is not possible. When “Service read possible” 1205 indicates that read is possible and “Characteristic read possible” 1207 indicates that read is possible, the information processing device 101 can read a value related to a corresponding characteristic. Also, when “Service read possible” indicates that read is possible and “Characteristic read possible” indicates that read is impossible, the information processing device 101 cannot read a value related to a corresponding characteristic.

“Value” 1210 indicates a value set to the respective characteristic. Also, when “Pairing necessary” 1211 indicates that pairing is unnecessary (blank indication), the information processing device 101 can read or write a value related to the corresponding characteristic even in a state in which it is not paired with the communication device 151. Meanwhile, when “Pairing necessary” indicates that pairing is necessary (o indication), the information processing device 101 cannot read or write a value related to the corresponding characteristic in a state in which it is not paired with the communication device 151.

In the present embodiment, between the information processing device 101 and the communication device 151 authentication is performed, and a pairing process for executing reading/writing of data by a GATT communication is executed between the devices. In a state in which the pairing process between the information processing device 101 and the communication device 151 has not been executed, the communication device 151 does not permit reading/writing of information by GATT communication. By such a configuration, it is possible to avoid the information processing device 101 and the communication device 151 performing communication even though they have not performed pairing, and avoid information that the communication device 151 holds being acquired improperly by an information processing device 101 with which pairing has not been performed. Note that in the present embodiment, both GATT communication that is permitted in a state in which pairing has not been performed and GATT communication that is not permitted in a state in which pairing has not been performed are possible. For example, for data with low confidentiality, it is possible to improve the convenience of communication by enabling communication by GATT communication that is permitted in a state in which pairing has not been performed. Meanwhile, for highly sensitive data, it is possible to increase communication security by enabling communication only by GATT communication for which permission is not given in a state in which pairing has been performed.

The details of the pairing process will be described. Firstly, the information processing device 101, in a case where the previously described print app is activated, and an instruction to execute the pairing process is received from a user via the print app, initiates a search for advertising information that has specific device information. Note that the specific device information is a UUID or MAC address of a device (printer or the like) corresponding to the print app, for example. Then, when the information processing device 101 receives advertising information that has the specific device information, a list of transmission source devices of the advertising information having specific device information is displayed on the display unit 108, and the device to be the target of pairing is selected by the user. Here, the communication device 151 is described as having been selected.

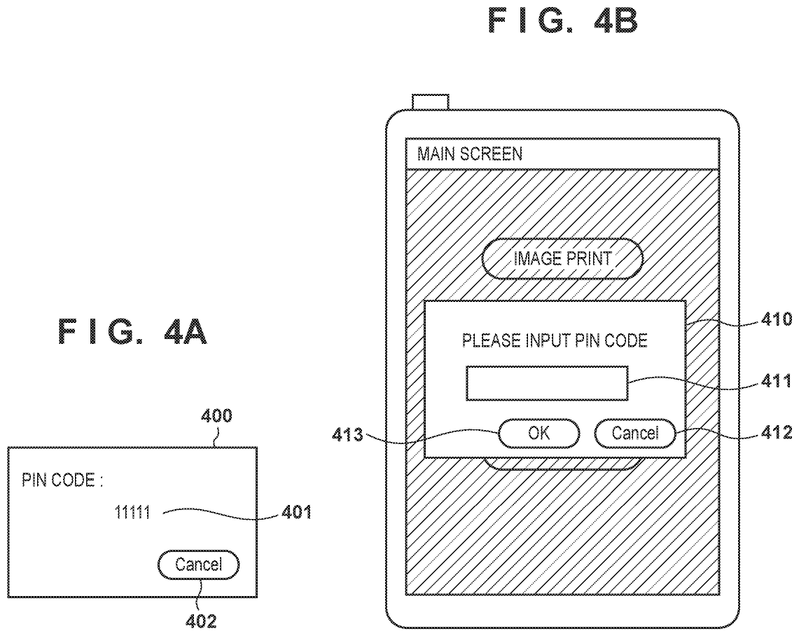

Also, the information processing device 101, in a case where selection of the device to be the target of pairing is received, transmits a pairing request to the communication device 151 by a communication according to a security manager protocol. Note that until the pairing ends, communication between devices is performed according to the security manager protocol. When the communication device 151 receives a pairing request, the communication device 151 displays a PIN code display screen 400 as illustrated on FIG. 4A on the display unit. A PIN code 401 and a Cancel button 402 for cancelling the pairing process are displayed on the PIN code display screen 400. Then, when the information processing device 101 transmits a pairing request, the PIN code input screen 410 as illustrated in FIG. 4B is displayed on the display unit 108. On the PIN code input screen 410, a PIN code input region 411 for receiving input for the PIN code 401 from a user, an OK button 413 for transmitting the inputted PIN code 401 to the communication device 151, and a Cancel button 412 for cancelling the pairing process are displayed. When, in a state in which the PIN code 401 has been inputted into the PIN code input region 411, the OK button 413 is pressed, the information processing device 101 transmits to the communication device 151 information including the inputted PIN code 401. In a case where the communication device 151 determines whether or not the PIN code 401 included in the received information matches the PIN code 401 displayed on the PIN code display screen 400 and determines that they do indeed match, the communication device 151 permits pairing to the information processing device 101. For example, the communication device 151 replaces a link key (authentication information) generated by a predetermined method based on the PIN code 401 with the information processing device 101 using the SMP (Security Manager Protocol) of the BLE standard. The replaced link key is saved respectively in the storage region (for example, the ROM 104) of the information processing device 101 and the storage region (for example, the ROM 152) of the communication device 151. Pairing is thus completed, and execution of BLE communication between the devices is permitted from then on. Note that the information processing device 101, when pairing completes, hides the PIN code input screen 410, and once again displays the original screen.

After the pairing completes, the information processing device 101 notifies to the communication device 151 the link key saved in the storage region at the time of the pairing process, when transmitting a GATT communication request to the communication device 151. Upon receiving the GATT communication request, the communication device 151 compares the link key saved in the storage region at the time of pairing processing with the notified link key, thereby confirming whether the device that has transmitted the GATT communication request is a paired device. If it can be confirmed that the device is a paired device, the communication device 151 starts reading/writing information according to the GATT communication with the information processing device 101. Accordingly, once pairing processing with the communication device 151 is completed, the information processing device 101 can execute GATT communication with the communication device 151 without input of the PIN code by the user thereafter. Note that, in the above, a mode in which the user is allowed to input the PIN code 401 into the PIN code input region 411 is described, but limitation is not made to this configuration. For example, configuration may be taken so that the PIN code 401 is stored in the information processing device 101 together with installation of the print app as static information a user cannot arbitrarily change, and so that the PIN code 401 is notified to the communication device 151 without input by the user. Also, the timing at which the pairing process is started is not limited to the above-described configuration, and may be a timing at which the user instructs printing via the print app and may be a timing prior to the BLE connection being performed in connection setting processing, for example.

Also, the PIN code input screen 410 that the information processing device 101 displays need not be displayed by the print app. For example, the information processing device 101 may have an application for settings (hereinafter, settings app). The settings app is an application program for performing settings related to functions that the OS carries out. Configuration may also be taken such that the settings app is installed in a series of processes installed on the information processing device 101 by the OS, for example, or that it is installed on the information processing device 101 already along with the OS when the information processing device 101 is shipped. The information processing device 101, when performing pairing with the communication device 151, may cause the settings app to activate and transition the print app to the background, and via a Bluetooth setting screen displayed by the settings app, may receive from a user input for pairing.

Above, a PIN code input type pairing method is described. However, the method of pairing is not limited to the above-described method. Below, description will be given of an example of a method of pairing other than the PIN code input type method. The information processing device 101 acquires, from the communication device 151 via the BLE connection, information that the communication device 151 holds and that is referred to as a key seed. Also, the information processing device 101 and the communication device 151 respectively generate a link key from the key seed in accordance with rules that they have respectively identified in advance. The generated link keys are saved respectively in the storage region (for example, the ROM 104) of the information processing device 101 and the storage region (for example, the ROM 152) of the communication device 151. In other words, the information processing device 101 and the communication device 151 each hold the same link key. By generating the link key in this manner and GATT communication using the link key becoming enabled, authentication between the communication device 151 and the information processing device 101 is performed, and the pairing process completes. After the pairing process completes, in communication between the information processing device 101 and the communication device 151, information encrypted based on the link key is communicated. The information processing device 101 and the communication device 151, in the case where information encrypted based on the link key is received, can recover the information prior to the encrypting by decrypting the encrypted data using the link key that they themselves hold.

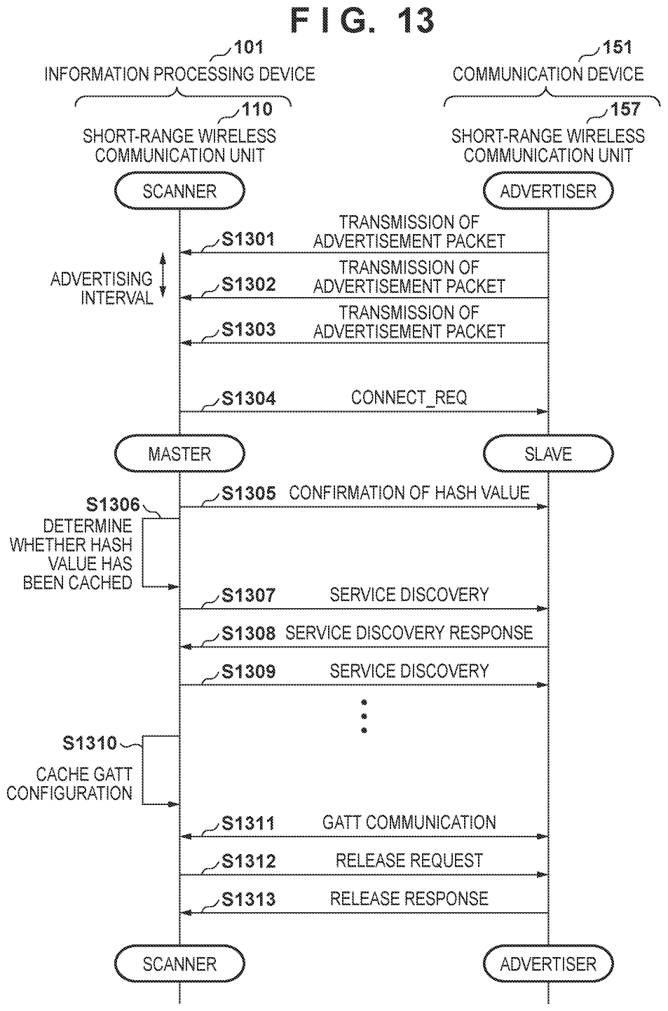

FIG. 13 is a sequence diagram for describing BLE communication between the information processing device 101 and the communication device 151. Processing of the communication device 151 illustrated in FIG. 13 is, for example, realized by the CPU 154 loading into the RAM 153 a control program stored in the ROM 152 or an HDD (not shown) that the communication device 151 comprises, and executing the control program. Processing of the information processing device 101 illustrated in FIG. 13 is, for example, realized by the CPU 103 loading into the RAM 105 a control program stored in the ROM 104 or an HDD (not shown) that the information processing device 101 comprises, and executing the control program.

In the description below, the communication device 151 is made to be the advertiser that transmits advertising information at predetermined intervals. Also, the information processing device 101 is made to be a scanner that waits for advertising information transmitted from an advertiser in the periphery. First, the short-range wireless communication unit 157 in the communication device 151 performs transmission of advertising information (step S1301 to step S1303). The information processing device 101 can recognize the presence of the communication device 151 by the short-range wireless communication unit 110 receiving the advertising information transmitted from the short-range wireless communication unit 157.

In the case where the information processing device 101 recognizes the communication device 151 and connects with the communication device 151, the information processing device 101 transmits connection request information to the communication device 151. For example, the short-range wireless communication unit 110 transmits CONNECT_REQ which requests the transition to a connection event for establishing a network connection by BLE (step S1304). When the short-range wireless communication unit 157 receives CONNECT_REQ, the information processing device 101 and the communication device 151 initiate transition to the connection event. For example, the short-range wireless communication unit 110 and the short-range wireless communication unit 157 make notifications to the CPU 103 and the CPU 154 respectively that processing for a connection for GATT communication has completed. After that, the information processing device 101 and the communication device 151 respectively transition from scanner and advertiser to master and slave, and the information processing device 101 which is the master and the communication device 151 which is the slave establish a connection (BLE connection) for GATT communication. Note that in the BLE standard, the master can form a “1:many” star-type topology with slaves. When the information processing device 101 and the communication device 151 establish a BLE connection, thereafter they can communicate data by the GATT communication scheme.

The information processing device 101, prior to accessing GATT data of the communication device 151 by the GATT communication, it is necessary to ascertain the configuration of the GATT data that the communication device 151 comprises. The configuration of the GATT data is, for example, the number of services in the GATT data, the number of characteristics, the respective UUID value, and the attributes indicating whether read is possible/impossible. The information processing device 101 acquiring the configuration of the GATT data is called discovery.

The information processing device 101, after the BLE connection is established in step S1304, initiates discovery in step S1305. For example, the information processing device 101 transmits to the communication device 151 a discovery request for requesting information indicating the configuration of the GATT data of the communication device 151. With this, as the response to the discovery request, the communication device 151 transmits information indicating the configuration of the GATT data to the information processing device 101. The information processing device 101, having received the information indicating the configuration of the GATT data, identifies a region in which a hash value is stored within the GATT data of the communication device 151, and reads the hash value. Note that the hash value is a value stored in a Database Hash characteristic where the Characteristic UUID in FIG. 12 is 0x2B2A, for example. The communication device 151 stores a hash value calculated in advance from the configuration of the GATT data as the value of the Database Hash characteristic. In other words, the hash value is a value that is uniquely defined in accordance with the configuration of the GATT data of the communication device 151.

Note that the information processing device 101 stores, in a memory (for example, the ROM 104) that the information processing device 101 comprises, hash values read from terminals that the information processing device 101 has connected to by BLE in the past. Accordingly, in step S1306, the information processing device 101 compares the hash value read in step S1305 and the hash values read in the past (the hash values stored in the memory that the information processing device 101 comprises), and determines whether they match (whether the hash value is already cached). In other words, the information processing device 101 determines whether the communication device 151 is a terminal to which the information processing device 101 has connected by BLE in the past. In this determination, the information processing device 101 may add to the determination condition, in addition to the hash value, other information such as device identification information such as the MAC address of the communication device 151.

In the case of determination of no match in step S1306, the information processing device 101 continues discovery in order to ascertain the remaining configuration of the GATT data of the communication device 151. To do so, the information processing device 101, in step S1307, transmits to the communication device 151 a discovery request for requesting information indicating the configuration of the GATT data of the communication device 151. The communication device 151, having received the discovery request, in step S1308, transmits (response) information indicating the configuration of the GATT data to the information processing device 101. Note that transmission/reception of the discovery request and transmission/reception of information indicating the configuration of the GATT data is repeated in proportion to the number of services, characteristics, and descriptors in the GATT data. For this reason, in step S1309, until the transmission of all of the information indicating the configuration of the GATT data completes, transmission/reception of a discovery request and transmission/reception of information indicating the configuration of the GATT data is repeated.

When the transmission of all of the information indicating the configuration of the GATT data completes, in step S1310, the information processing device 101 stores the configuration of the GATT data of the communication device 151 in memory that the information processing device 101 comprises as a cache. At that time, the information processing device 101 stores, into memory, a cache of the configuration of the GATT data of the communication device 151 and the hash value acquired from the communication device 151 in association. Note that the information processing device 101 may store to memory other information such as device identification information such as the MAC address of the communication device 151 in association therewith. Note that in the case where it is determined that there is a match in step S1306, the information processing device 101 has already cached the configuration of the GATT data of the communication device 151, and so the processing of steps S1307 to S1310 is skipped. By acquiring the configuration of the GATT data of the communication device 151, thereafter it is possible for the information processing device 101 to freely perform GATT communication with the communication device 151. The information processing device 101, in step S1311, freely performs GATT communication with the communication device 151.

After the GATT communication completes, the information processing device 101, in step S1312, transmits a release request. The communication device 151, after having received the release request, transmits a release response in step S1313, and ends the BLE connection between the devices. When the BLE connection between the devices has ended, the information processing device 101 and the communication device 151 respectively return to scanner and advertiser, and the communication device 151 resumes transmission of advertising information.

The communication device 151 of the present embodiment transmits information for causing the execution of a notification related to the communication device 151 in the information processing device 101. By executing the notification processing based on the received information, the information processing device 101 can notify the user of various information related to the communication device 151. For example, information regarding an error that occurred on the communication device 151 and information related to the progress of print processing or scan processing executed on the communication device 151 can be notified to the user. The user, after confirming what information was notified, can then move to the position of the communication device 151 and resolve the error or recover a print material or the like.

In the present embodiment, the information processing device 101 specifies by BLE the direction in which the communication device 151 is positioned and distance thereto. Then, the information processing device 101, in the case of making a notification related to the communication device 151, notifies the user of the direction in which the communication device 151 is positioned and the distance thereto that were specified by BLE. The result of that is that the user can easily know what the position of the communication device 151 is, and so the convenience of the user is improved when they move to the position of the communication device 151 after the notification related to the communication device 151.

<Configuration of Notification System>

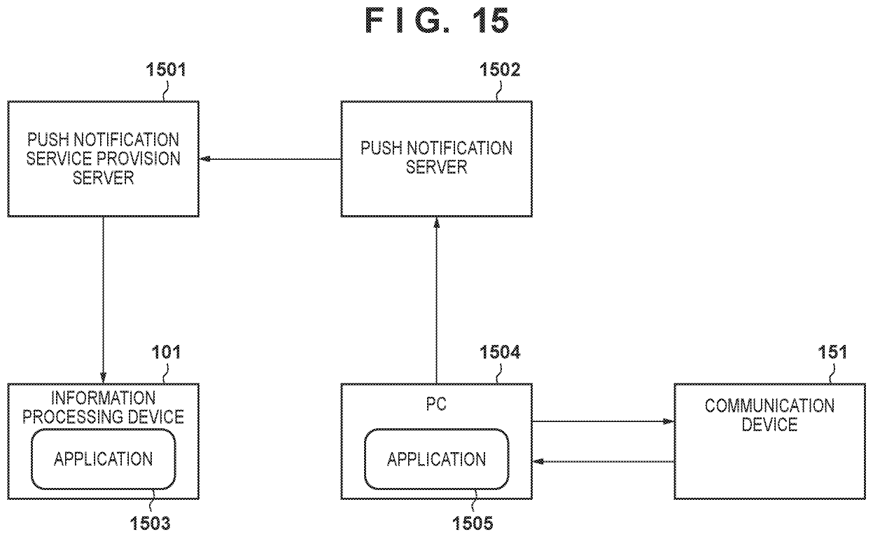

First, a system configuration for realizing the present embodiment will be described. FIG. 15 is a view illustrating an example of a configuration of a communication system that performs push notifications in the present embodiment. The present system includes the communication device 151, a push notification server 1502, the information processing device 101, a push notification service provision server (hereinafter, the service provision server) 1501, and a PC 1504.

The information processing device 101 displays on the display unit 108 information based on notification information transmitted from the service provision server 1501. Also, the information processing device 101 stores an application 1503. The application 1503 corresponds to the above-described print app. The application 1503 has a function in which notification information transmitted from the service provision server 1501 is analyzed, and the result of that analysis is notified to the OS to cause the OS to display a message based on the notification information. The information processing device 101 can communicate with the service provision server 1501 via the Internet, for example, and receive notification information via the Internet. Note that the information processing device 101 may communicate with the Internet via a 4G or LTE mobile communication network, and may communicate with the Internet via a Wi-Fi connection with a wireless LAN router (not shown).

The communication device 151 transmits to the PC 1504 information for making a notification regarding the communication device 151. As will be described later, with the transmission of such information as a trigger, a notification related to the communication device 151 is made in the information processing device 101. Note that the communication device 151 may transmit information for making a notification related to the communication device 151 directly to the information processing device 101.

The PC 1504 is a typical personal computer, and stores an application 1505. The application 1505 of the PC 1504, by communicating with the communication device 151, acquires notification information related to the communication device 151. Then, the PC 1504, in order to cause the information processing device 101 to display the notification information, transmits the notification information to the push notification server 1502. The notification information may be data encrypted by using a security key shared by the push notification server 1502 and the application 1505. Also, the notification information may be binary data, and may be UTF-8 text data or data encoded in a Base64 format or the like. Also, the functions of the PC 1504 may be embedded in the communication device 151.

When the push notification server 1502 receives the notification information from the PC 1504, the push notification server 1502 transmits to the information processing device 101 via the service provision server 1501 notification information corresponding to a push notification service generated based on the notification information. Note that the push notification server 1502 may transmit notification information to the information processing device 101 via the service provision server 1501 so as to cause a plurality of devices to display the information.

The service provision server 1501 is a server that provides a push notification service. In the present embodiment, OSes have a push notification function for displaying a notification region on the display unit by push notification, and therefore the push notification service corresponding to the respective OS must be used in order to utilize this function. In other words, the push notification server 1502 must transmit the notification information via the service provision server 1501 rather than transmit it directly to the information processing device 101. The push notification service that is used differs for each OS of the information processing device 101 that receives the notification made by push notification. In other words, the push notification server 1502 transmits the notification information to the information processing device 101 via different service provision servers 1501 for respective OSes of the information processing device 101 targeted for the push notification. Note that communication between the push notification server 1502 and the information processing device 101 is unidirectional communication in which the only active accessing that is possible is from the push notification server 1502 side.

In the present embodiment, the push notification server 1502 and the service provision server 1501 are described as each being configured using a single server, but there is no limitation to such a configuration. A server system corresponding to the push notification server 1502 and the service provision server 1501 may be constructed by a plurality of servers operating cooperatively. Also, the functions of the push notification server 1502 and the service provision server 1501 may be embedded in the communication device 151.

<Regarding Processing for Registration for Push Notifications>

In order to perform push notifications to the information processing device 101, it is necessary that processing for registering for push notifications be executed in advance. Note that processing on the PC 1504 in the registration processing below is realized by a CPU of the PC 1504 executing the application 1505, for example. Also, processing of the information processing device 101 in the registration processing below is realized by the CPU 103 executing the application 1503.

First, the PC 1504, after receiving a predetermined operation for generation of a QR code (registered trademark) from a user, displays the QR code on the display unit of the PC 1504. Next, the information processing device 101 reads the QR code using a camera (not shown) that the information processing device 101 comprises. Then, by analyzing the QR code that was read, information for identifying the application 1505 that generated the QR code and information of a user that is registered to the application 1505 that generated the QR code are acquired.

Next, the information processing device 101 transmits, as registration information, to the push notification server 1502 via the Internet the information for identifying the information processing device 101 and the above-described information obtained by analyzing the QR code. Note that the server name and the address of the push notification server 1502 used as the address of the destination of the registration information are assumed to be stored in advance in the application 1503. In the information for identifying the information processing device 101, for example, a device token necessary for push notification reception and OS information (the type of OS, the version of the OS) related to an OS that the information processing device 101 has are included. The device token is information that is provided from the OS that the information processing device 101 stores, and includes information for identifying the application 1503 or the like.

The information transmitted to the push notification server 1502 may be acquired by a method other than QR code. For example, configuration may be such that first, the information processing device 101 reads information that the PC 1504 displays in text format by using a camera (not shown) that the information processing device 101 comprises. Then, the information processing device 101, by analyzing the read information by OCR (Optical Character Recognition/Reader), extracts the information to transmit to the push notification server 1502. Also, for example, the information processing device 101 connects by a wireless communication method or a wired communication method with the PC 1504, and acquires information for transmission to the push notification server 1502 via that connection.

Thereby, the push notification server 1502 recognizes which information processing device 101 to transmit the notification information to based on which application 1505 the notification message was received from. The registration processing thus completes.

Note that in the present embodiment, a configuration in which information for identifying the application 1505 and information for identifying the information processing device 101 are managed in association by the push notification server 1502 is described, but limitation is not made to this configuration. For example, configuration may be such that by the QR code, information for identifying the PC 1504 that displays the QR code is acquired. Then, the information for identifying the PC 1504 and the information for identifying the information processing device 101 may be managed in association by the push notification server 1502. In such a case, the push notification server 1502 recognizes which information processing device 101 to transmit the notification information to based on which PC 1504 the notification message was received from.

Also, for example, the information processing device 101 may acquire the information for identifying the communication device 151 being controlled by the application 1505 by reading the QR code. Then, the information for identifying the communication device 151 and the information for identifying the information processing device 101 may be managed by the push notification server 1502 in association. In such a case, the push notification server 1502 recognizes which information processing device 101 to transmit the notification information to based on which communication device 151 the notification message is related to.

Also, the registration processing may be executed by the following method, for example. Firstly, the information processing device 101 connects with the PC 1504 by the wireless communication method or the wired communication method, and transmits the information for identifying the information processing device 101 to the PC 1504 via that connection. The PC 1504 transmits, as registration information, to the push notification server 1502 via the Internet the information for identifying the application 1505 and the information for identifying the information processing device 101. In this manner, when the information for identifying the application 1505 and the information for identifying the information processing device 101 are caused to be managed by the push notification server 1502 in association, the registration processing completes. Note that, configuration may be taken such that the information for identifying the PC 1504 and the information for identifying the information processing device 101 are managed by the push notification server 1502 in association even in this registration processing. Also, the information for identifying the communication device 151 and the information for identifying the information processing device 101 may be managed in association by the push notification server 1502.

Note that there is no particular limitation on the method for transmitting the registration information in the registration processing. For example, the registration information may be converted into the HTML format and transmitted by HTTP, or the registration information may be generated in a file format and the file transmitted by FTP. Also, the registration information may be data that is encrypted using a security key shared between the push notification server 1502 and the application 1503. Also, the notification information may be binary data, and may be UTF-8 text data or data encoded in a Base64 format or the like.

<Regarding Push Notification>

“push notification” is a method by which the information processing device 101 is notified using a push notification service. In the present embodiment, the PC 1504 transmits to the push notification server 1502 notification information (information related to the communication device 151) received from the communication device 151. Then, the push notification server 1502 transmits to the service provision server 1501 the notification information that was transmitted. Thereafter, the service provision server 1501 transmits to the information processing device 101 the notification information. Note that the notification information transmitted from the communication device 151 may be converted in the respective device to a data format that is different to the original data format (the data format prior to reception in the respective device). The information processing device 101, in the case of having received notification information, newly displays a notification region for notification of a message corresponding to the notification information on a screen that the display unit 108 displays.

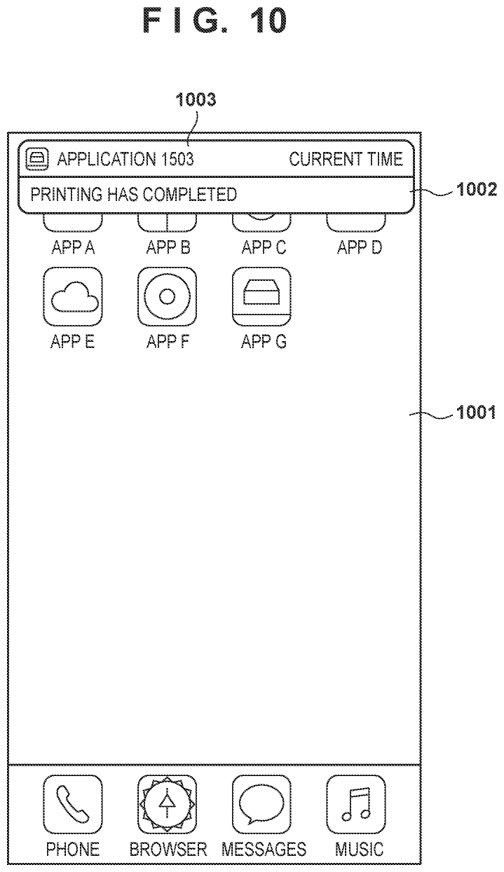

FIG. 10 is one example of a screen in a state in which the push notification region is displayed by the push notification function. A maximum region 1001 indicates a maximal region in which the display unit 108 can display, and the notification region 1002 indicates a notification region for making notifications of messages corresponding to the notification information. Also, the region 1003 illustrates an icon indicating which application the displayed notification region corresponds to or information related to the name of the application that the displayed notification region corresponds to. For example, in the case where a notification made by the application 1505 of the PC 1504 is displayed, the application that the notification region corresponds to is the application 1503.

Note that in the present embodiment, the push notification function for displaying a notification region by a push notification on a display unit is realized by an OS that the information processing device 101 is equipped with. The push notification function is a function by which a notification can be sent to the application 1503 even in a state in which the application 1503 is not activated on the information processing device 101. In other words, by the push notification function, the information processing device 101 can display the notification region 1002 in a state in which the application 1503 is operating in the background or is not activated or a state in which a home screen is being displayed.

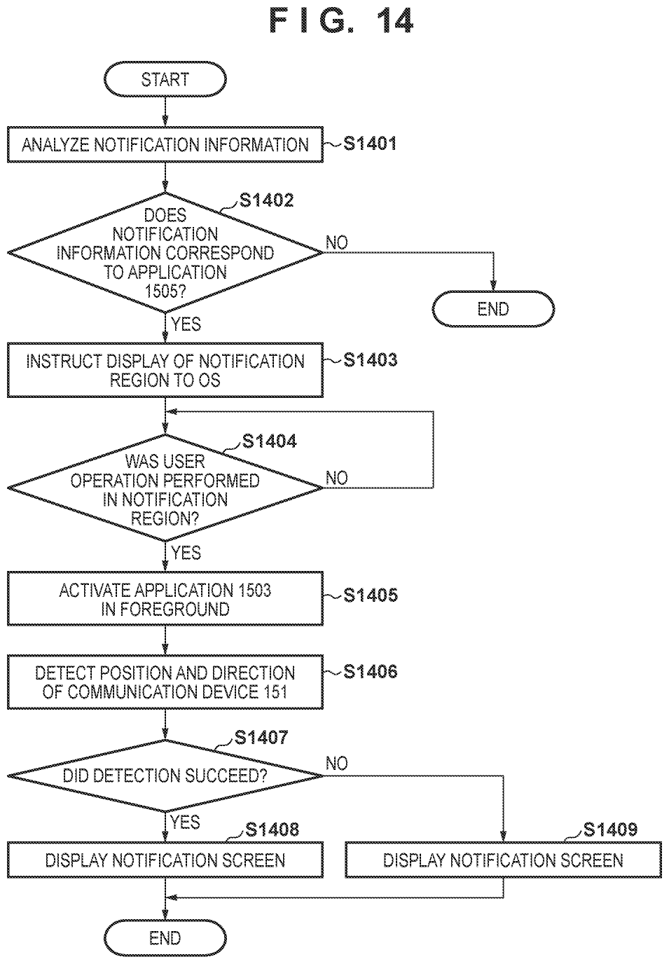

FIG. 14 is a flow chart that illustrates display control processing that the information processing device 101 executes in the present embodiment. The respective processes that the flow chart illustrated in FIG. 14 indicates are, for example, realized by the CPU 103 reading the application 1503 which is stored in the ROM 104 or the like into the RAM 105 and executing the application 1503.

When notification information is received by the information processing device 101 via the service provision server 1501, first the CPU 103 analyzes the notification information using the OS of the information processing device 101. In the notification information, information of the application corresponding to the notification information is included, and therefore the CPU 103 identifies which application the received notification information corresponds to. Here, since the notification information corresponds to the application 1503, the CPU 103 transmits the notification information to the application 1503. Note that configuration may be such that when the notification information is received, the below processing executed by the application 1503 may be executed in a state in which the application 1503 is not operating in the foreground.

First, in step S1401, the CPU 103, after receiving the notification information by the application 1503, initiates analysis of the notification information. Next, in step S1402, the CPU 103 determines whether or not the notification information is based on information transmitted from application 1505. In this determination, for example, it is determined whether information in a key/value format or a particular text sequence is included in the notification information. The CPU 103, in the case where it is determined that the notification information is based on information transmitted from application 1505, advances to step S1403, and in the case where it is determined that the notification information is not based on information transmitted from application 1505, ends the processing of FIG. 14 without displaying the notification region 1002.

Next, in step S1403, the CPU 103 makes a notification (instruction) to the OS of the information processing device 101 so that the notification region 1002 be newly displayed on the display unit 108 based on the received notification information. Thereby, the notification region 1002 is newly displayed on the display unit 108 based on the received notification information.

Next, in step S1404, the CPU 103 determines whether or not a user operation corresponding to the notification region 1002 was made. The user operation is, for example, a click operation. In a case where it is determined that a user operation was made, the processing advances to step S1403, and in a case where it is determined that a user operation was not made, the processing of step S1404 is repeated.

Next, in step S1405, the CPU 103 causes the application 1503 to be activated in the foreground.

Next, in step S1406, the CPU 103, by the short-range wireless communication unit 110, detects the distance between the information processing device 101 and the communication device 151 and the direction in which the communication device 151 is positioned in relation to the information processing device 101. The details of this processing are as described using FIG. 5 to FIG. 8. Note that in the case where multiple devices transmitting advertising information are present in the surroundings of the information processing device 101, a communication device 151 is identified from among the plurality of devices present in the surroundings of the information processing device 101 by referencing the identification information included in the advertising information. Also, based on the advertising information that the identified communication device 151 emits, the distance and direction are detected. Also, the timing at which the distance between the information processing device 101 and the communication device 151 and the direction in which the communication device 151 is positioned with respect to the information processing device 101 are detected is not limited to this timing. For example, the detection timing may be when the notification information is received, and may be when the advertising information that the communication device 151 emits is received. In such cases, the CPU 103 stores, in memory, information related to the detected distance and direction.

Next, in step S1407, the CPU 103 determines whether or not the detection of the distance between the information processing device 101 and the communication device 151 and the direction in which the communication device 151 is positioned with respect to the information processing device 101 succeeded. The CPU 103, in a case where the detection is determined to have succeeded, advances to step S1408, and in a case where the detection is determined to not have succeeded, advances to step S1409. A case where the detection is determined to have not succeeded due to a failure is, for example, when the information processing device 101 and the communication device 151 are too far apart, or when a BLE function is not enabled in the information processing device 101 or the communication device 151.

Next, in step S1408, the CPU 103 displays, together with information displayed in the notification region 1002, information for notifying the user of the distance between the information processing device 101 and the communication device 151 and the direction in which the communication device 151 is positioned in relation to the information processing device 101.

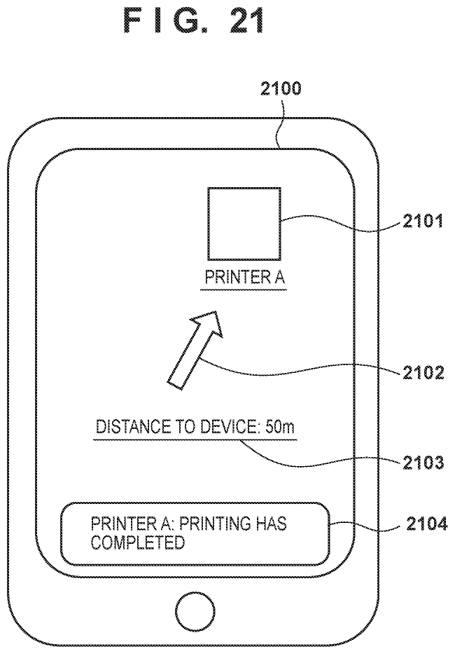

FIG. 21 is a view for illustrating an example of a notification screen 2100 displayed on the information processing device 101 at this time. In a region 2104, a message (a message based on the received notification information) that is being displayed on the notification region 1002 is displayed. In a region 2103, the distance between the information processing device 101 and the communication device 151 is displayed as a message. An arrow 2102 is an object indicating the direction in which the communication device 151 is positioned in relation to the information processing device 101. In a region 2101, an object denoting the communication device 151 is displayed.

As illustrated in FIG. 21, by displaying the direction of the communication device 151 graphically based on the position of the information processing device 101, it is possible to enable a user to recognize the position of the communication device 151 intuitively.

Note that this notification screen is displayed by the application 1503 which is operating in the foreground. Accordingly, unlike the push notification, the region in which the notification information can be displayed is large. Accordingly, for example, details of the information displayed in the notification region 1002 may be displayed on this notification screen. For example, in the case where the information displayed in the notification region 1002 is information for notifying that an error related to a consumable item such as ink or paper (an ink outage error or the like) occurred in the communication device 151, information such as the type or model number of the ink in the ink outage may be displayed.

In a case where the detection is determined to not have succeeded in step S1407, in step S1409, the CPU 103 displays the information being displayed on the notification region 1002, and does not display information for notifying the user of the distance between the information processing device 101 and the communication device 151 and the direction in which the communication device 151 is positioned in relation to the information processing device 101. However, details of the information being displayed on the notification region 1002 may also be displayed on the notification screen displayed at this time, similarly to in step S1408. Also, at this time, a message for notifying that detection of the distance between the information processing device 101 and the communication device 151 and the direction in which the communication device 151 is positioned with respect to the information processing device 101 failed may be displayed. Also, information indicating the reason for the detection failure may be displayed. The reason for the detection failure may be that the information processing device 101 and the communication device 151 are too far apart or that the BLE function is not enabled in the information processing device 101 or the communication device 151, for example.

By the above operation, it is possible to notify the user of the distance between the information processing device 101 and the communication device 151 and the direction in which the communication device 151 is positioned in relation to the information processing device 101. As a result, it is possible to improve the convenience of the user in moving to the communication device 151.

Note that in the description above, the notification information that the communication device 151 transmits is transmitted to the information processing device 101 via the PC 1504 and various servers, and the information processing device 101 is configured to make a notification based on the received information, but limitation is not made to this configuration. For example, the notification information that the communication device 151 transmits may be transmitted directly to the information processing device 101.

Also, in the above, a configuration in which information related to the communication device 151 is notified by the push notification function is described, but limitation is not made to such a configuration. The information for notifying in the notification region 1002 in the above may be transmitted to the information processing device 101 by the push notification function. For example, the information for notification in the notification region 1002 in the above may be included in advertising information that the communication device 151 emits. In other words, configuration may also be taken such that the information processing device 151 does not only use the BLE function for detection of the distance and direction of the communication device 151, but also uses it for reception of notification information.

Also, in the above, a configuration in which in the case where an operation is made on the notification region 1002, a notification screen including the distance and direction of the communication device 151 is displayed was described, but limitation is not made to such a configuration. For example, in a case where the application 1503 is activated by an operation being made on an icon corresponding to the application 1503 in the home screen, a notification screen including the distance and direction of the communication device 151 is displayed.

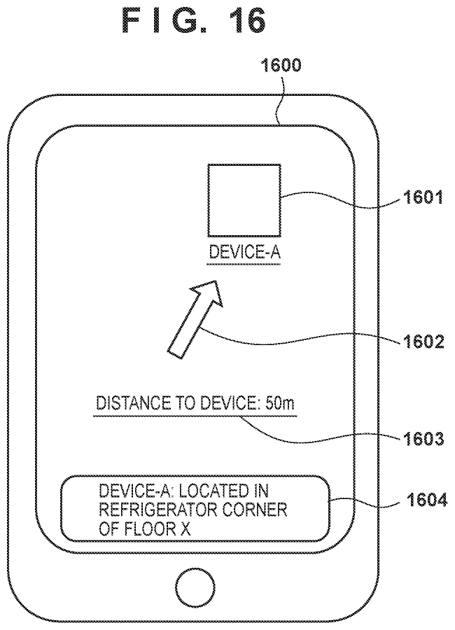

Also, in the above, description is made of a configuration in which the communication device 151 is a printer, and information related to the printer is notified in an information processing device 101, but limitation is not made to such a configuration. The communication device 151 may be a device other than a printer, and information related to a device other than the printer may be notified in the information processing device 101. For example, configuration may be taken such that the notification system is configured in a consumer electronics store, and the communication device 151 is installed in respective sales areas of the consumer electronics store. FIG. 16 is a view illustrating an example of a notification screen displayed on the information processing device 101 in such a configuration. The notification screen 1600 is configured to include an object 1601 indicating the device that is the notification target, the direction 1602 to the device that is the notification target, the distance 1603 to the device that is the notification target, and a notification message 1604. Device identification information, for example, may be displayed in addition to the object 1601 indicating the device that is the notification target, and a name that identifies the communication device 151 which is included in the notification information may be additionally displayed. The display parts for the direction 1602 toward the device of the notification target and the distance 1603 to the device that is the notification target are generated in the application 1505. Configuration may also be taken such that the notification message 1604 is displayed based on, for example, information for notification included in the advertising information that the foregoing communication device emits rather than the push notification function. Also, the notification message 1604, in the notification information notification screen 1600, may generate/display map information or arrangement information based on information on the position of the device that is the notification target.

Also, in the above, in the detection of the position of the communication device 151, the configuration is such that the distance between the information processing device 101 and the communication device 151 and the direction in which the communication device 151 is positioned in relation to the information processing device 101 are detected, but limitation is not made to this configuration. Configuration may be taken so as to detect only one of the distance between the information processing device 101 and the communication device 151 and the direction in which the communication device 151 is positioned in relation to the information processing device 101, or so that the user is notified of only one of these.

### Second Embodiment

Below, points in the present embodiment that differ from the first embodiment will be described. In the present embodiment, in step S1407 of FIG. 14, in the case where there is notification information that was notified from a plurality of communication devices 151, the notification information of the communication device 151 that is closest to the information processing device 101 is displayed.

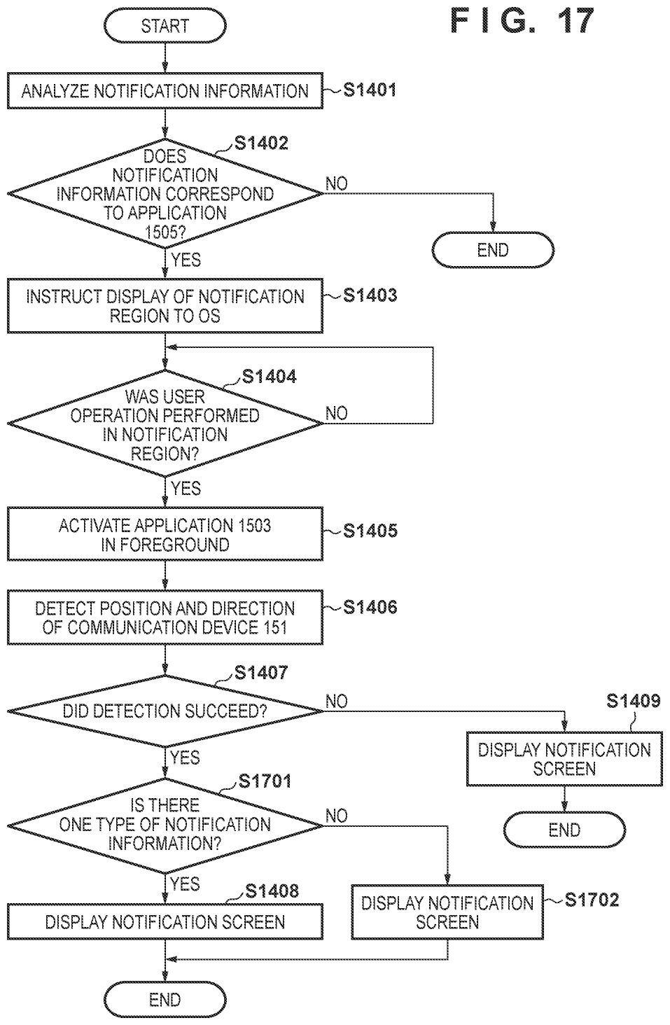

FIG. 17 is a flow chart illustrating display control processing that the information processing device 101 executes in the present embodiment. Regarding step S1401 to step S1409 of FIG. 17, the description is the same as in step S1401 to step S1409 of FIG. 14, and so unless otherwise noted, description thereof will be omitted.

In a case where in step S1407 it is determined that the detection of the distance between the information processing device 101 and the communication device 151 and the direction in which the communication device 151 is positioned in relation to the information processing device 101 succeeded, the processing of step S1701 is performed.

In step S1701, the CPU 103 determines whether or not the notification information received in step S1401 is of one type. In the case where the received notification information is determined to be of one type, the processing of step S1408 is performed. Meanwhile, in a case where it is determined that the received notification information is not of one type but of multiple types, in step S1702, the CPU 103 decides the communication device 151 which is closest to the information processing device 101 among the communication devices 151 detected in step S1406. Also, the CPU 103, in addition to the information displayed on the notification region 1002, displays information for notifying the user of the distance between the information processing device 101 and the decided communication device 151 and the direction in which the decided communication device 151 is positioned in relation to the information processing device 101.

As described above, by virtue of the present embodiment, it is possible to enable a user to know about the communication device 151 which is closest to the information processing device 101. As described above, configuration may also be taken such that the closest communication device 151 to the information processing device 101 is decided as the display target, but a closest predetermined number of devices may be displayed in a list. By such a configuration, the user can determine in what sequence to go around in relation to the plurality of communication devices 151.

### Third Embodiment

Differences from the first and second embodiments will be described below. In the first embodiment, it was explained that a display may be as illustrated in FIG. 16. In FIG. 16, the object 1601 which indicates the device that is the notification target is displayed on the notification information display screen. Here, in a case where the distance from the information processing device 101 to the communication device 151 is large, there are times when one arrives at the destination faster if landmarks such as floor information or a store/facility name or the like is displayed on the display screen.

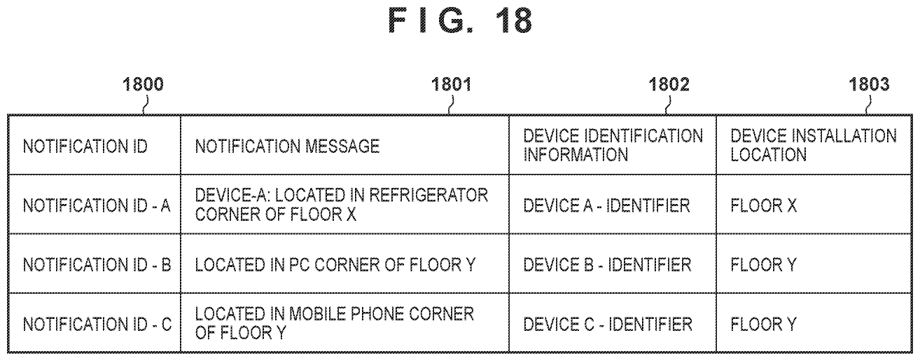

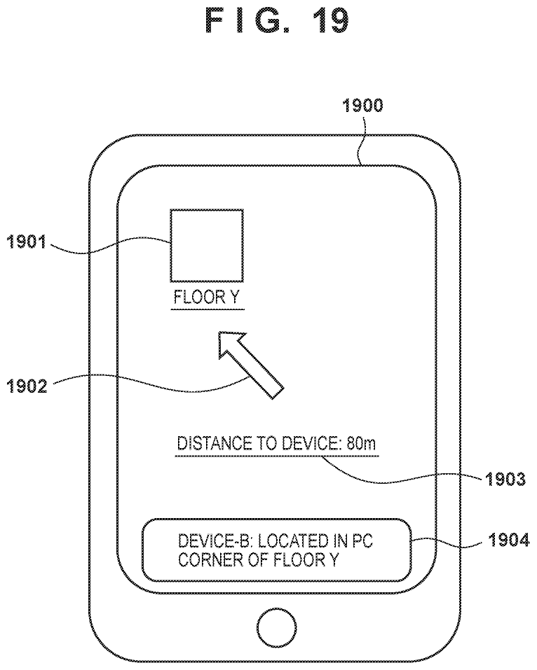

FIG. 18 is a view illustrating an example of notification information in which device installation location information is embedded in the notification information notified from the communication device 151. In the notification information, a notification message 1801, device identification information 1802, and a device installation location 1803 are associated with each corresponding notification ID 1800. The installation location 1803 records information related to the location where the communication device 151 is installed such as a floor name, a store name, or a facility name, for example landmark information. In the information processing device 101, after receiving the notification information of FIG. 18, in a case where the distance to the communication device 151 is greater than a reference value, the screen illustrated in FIG. 19 is displayed, unlike when the distance is the reference value or less.

FIG. 19 is a view illustrating an example of a notification information display screen in the information processing device 101, and is configured to include an object 1901 indicating the installation location of the device that is the notification target, a direction 1902 in which the device that is the notification target is positioned, a distance 1903 to the device that is the notification target, and a notification message 1904. Unlike in FIG. 16, the device installation location 1803 is displayed in place of the name of the communication device 151 for the object 1901 indicating the installation location of the device that is the notification target.

As illustrated in FIG. 19, guidance information (floor information or the like) for helping the user to go to the location of the communication device 151 is displayed as the communication message 1904. As a result, it is possible to improve the convenience of the user in moving to the location at which the communication device 151 is positioned.

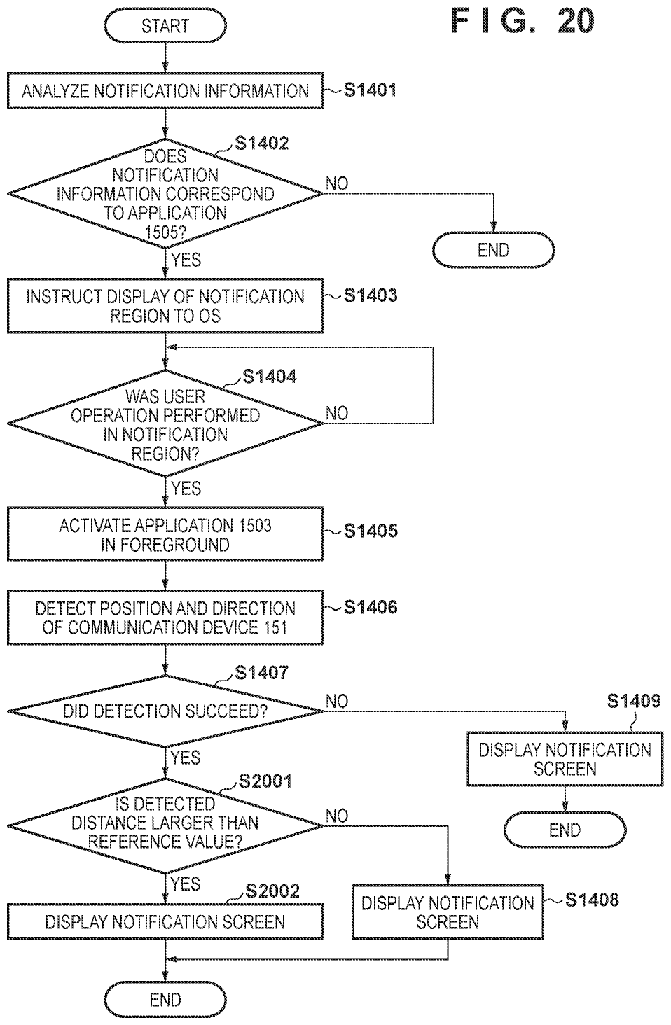

FIG. 20 is a flow chart illustrating display control processing that the information processing device 101 executes in the present embodiment. Regarding step S1401 to step S1409 of FIG. 20, the description is the same as in step S1401 to step S1409 of FIG. 14, and so unless otherwise noted, description thereof will be omitted.

In a case where in step S1407 it is determined that the detection of the distance between the information processing device 101 and the communication device 151 and the direction in which the communication device 151 is positioned in relation to the information processing device 101 succeeded, the processing of step S2001 is performed.

In step S2001, the CPU 103 determines whether or not the distance to the notification device 151 that was detected in step S1406 is larger than a reference value. In a case where the distance is determined to be larger than the reference value, the processing advances to step S2002, the CPU 103 displays the screen of FIG. 19, and thereafter ends the processing of FIG. 20. Meanwhile, in a case where it is determined not to be larger than the reference value, the processing advances to step S1408.

As described above, by virtue of the present embodiment, in a case where the distance to the communication device 151 detected is larger than the reference value, in place of the name of the communication device 151, another name such as the name of the floor on which the communication device 151 is positioned or the like is used in the display. Thereby, even in the case where there is a communication device 151 at a position that a user cannot easily discover, the name of the floor on which the communication device 151 is positioned or the like is displayed, and thereby it is possible to improve convenience of the user in moving to the communication device 151.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-103171, filed May 31, 2019, which is hereby incorporated by reference herein in its entirety.

What is claimed is:

1. A display control method performed on an information processing device operable to communicate with a communication device, the method comprising:
acquiring information of a relative position between the information processing device and the communication device specified based on a signal emitted from the communication device;
causing a display unit to display predetermined notification information that is different to the relative position information and that is related to the communication device and the relative position information, together with information related to the communication device.

2. The method according to claim 1, wherein in accordance with activation of a program, the predetermined notification information and the relative position information are caused to be displayed together with the information related to the communication device.

3. The method according to claim 1, wherein in accordance with a user operation being made in related to a push notification region displayed by a push notification function of an operating system that the information processing device has, the predetermined notification information and the relative position information are caused to be displayed together with the information related to the communication device.

4. The method according to claim 3, wherein in accordance with the user operation in relation to the push notification region being performed, the relative position information is acquired.

5. The method according to claim 3, wherein
information for displaying the push notification region is received by the information processing device by a first communication method, and
the signal is received by the information processing device by a second communication method different to the first communication method.

6. The method according to claim 5, wherein the first communication method is Wi-Fi, and the second communication method is Bluetooth Low Energy.

7. The method according to claim 1, wherein the predetermined notification information includes information regarding an error that occurred on the communication device.

8. The method according to claim 1, wherein the predetermined notification information includes information regarding progress of processing that the communication device performs.

9. The method according to claim 1, wherein at least one of information related to a direction of the communication device from the information processing device and information related to a distance between the information processing device and the communication device is acquired as the relative position information.

10. The method according to claim 9, wherein by a graphical display based on a position of the information processing device, the display unit is caused to display the information related to the direction of the communication device.

11. The method according to claim 9, wherein in a case where the distance is larger than a reference value, the display unit is caused to display the information related to the direction of the communication device, and in a case where the distance is less than or equal to the reference value, the display unit is not caused to display the information related to the direction of the communication device.

12. The method according to claim 1, wherein the display unit is caused to further display information related to a location where the communication device is present.

13. The method according to claim 12, wherein the display unit is caused to display guidance as to a direction towards the location at which the communication device is present.

14. The method according to claim 1, wherein the relative position information includes information related to the direction of the communication device from the information processing device, which is specified based on an angle of arrival of the signal.

15. The method according to claim 1, wherein the relative position information includes information related to a distance of the communication device from the information processing device, which is specified based on a reception strength of the signal.

16. The method according to claim 1, wherein the signal is received by the information processing device by short-range wireless communication.

17. The method according to claim 16, wherein the short-range wireless communication is Bluetooth Low Energy.

18. The method according to claim 16, wherein the short-range wireless communication is Bluetooth Low Energy included in a Bluetooth 5.1 standard.

19. The method according to claim 1, further comprising transmitting a print job for causing the communication device to perform printing.

20. An information processing device operable to communicate with a communication device, the information processing device comprising:
an acquiring unit configured to acquire information of a relative position between the information processing device and the communication device specified based on a signal emitted from the communication device; and
a display control unit configured to cause a display unit to display predetermined notification information that is different to the relative position information and that is related to the communication device and the relative position information, together with information related to the communication device.
